(19) United States
(12) Patent Application Publication
(10) Pub. No.: US 2026/0179526 A1
(43) Pub. Date: Jun. 25, 2026

(54) REDUCING THE ACTIVE AREA OF A DISPLAY PANEL TO SAVE POWER

(71) Applicant: Intel Corporation, Santa Clara, CA (US)

(72) Inventors: Mukesh Arora, Bangalore (IN); Kumar K M, Banglore (IN); Tamoghna Ghosh, Bangalore (IN); Susanta Bhattacharjee, Bangalore (IN); Vishal Ravindra Sinha, Portland, OR (US); Roland P. Wooster, Folsom, CA (US)

(73) Assignee: Intel Corporation, Santa Clara, CA (US)

(21) Appl. No.: 19/001,025

(22) Filed: Dec. 24, 2024

(51) Int. Cl. G09G 3/20; G09G 3/32; G09G 3/3208; G09G 3/34

(52) U.S. Cl. CPC G09G 3/2096; G09G 3/32; G09G 3/3208; G09G 3/3426; G09G 2330/023; G09G 2340/0407

(57) ABSTRACT

Devices, systems, and methods for reducing the viewable area of a display panel to conserve power are disclosed herein. In one example, an electronic device includes a display panel and processing circuitry. The processing circuitry reduces the size of the viewable area of the display panel and further deactivates an area of the display panel outside the viewable area. The area outside the viewable area becomes a deactivated area of the display panel, and the power consumed by the display panel decreases based on the deactivated area.

### BACKGROUND

Display panels are some of the most power-hungry components of client devices. This is particularly true for modern display panels, such as those based on light-emitting diode (LED) technology (e.g., organic LED (OLED), micro-LED, mini-LED), as they often support increasingly higher resolutions and refresh rates, along with wider ranges of brightness, contrast, and color.

While various power saving features are available to extend the battery life of client devices, they are disfavored by many end users, as they often restrict the functionality of the devices in unacceptable ways. For example, some power-saving features may limit certain tasks (e.g., background activities, push notifications), while others may aggressively reduce screen brightness, disable wireless connectivity (e.g., Bluetooth, Wi-Fi, cellular), or deactivate global positioning system (GPS) functionality.

### BRIEF DESCRIPTION OF THE DRAWINGS

FIG. 1 illustrates a system with a power saving mode that reduces the active area of a display panel to conserve power.

FIGS. 2A-D illustrate examples of a display panel with an active area reduced by various percentages.

FIGS. 3A-D illustrate examples of a display panel with active and inactive areas defined based on dimming zones.

FIGS. 4A-D illustrate examples of a display panel with various arrangements of active and inactive areas.

FIG. 5 illustrates a display layout interface with preconfigured display layouts for reducing the active area of a display panel.

FIG. 6 illustrates a process flow for reducing the active area of a display panel to conserve power.

FIG. 7 illustrates an example computing system.

FIG. 8 illustrates an example processor unit.

### DETAILED DESCRIPTION

Display panels are often some of the most power-hungry components of client devices, such as laptops, tablets, smartphones, and other end-user electronic devices. This is particularly true for modern display panels that support increasingly higher resolutions and refresh rates, along with wider ranges of brightness, contrast, and color (e.g., for high dynamic range (HDR) content). Many modern display panels rely on light-emitting diode (LED) technologies, such as organic LED (OLED), micro-LED, and mini-LED, and adoption of these display panels is expected to increase considerably in the coming years. Any reduction in power usage by modern display panels can greatly enhance the battery life of client devices.

While various power saving features are available to extend the battery life of client devices, they are disfavored by many end users, as they often restrict the functionality of the devices in ways that are unacceptable to the end users. For example, some power-saving features may limit certain tasks, such as background activities and push notifications, while others may aggressively reduce screen brightness, disable wireless connectivity (e.g., Bluetooth, Wi-Fi, cellular), or deactivate global positioning system (GPS) functionality.

Accordingly, this disclosure presents embodiments of devices and systems with a power saving mode that reduces the active (e.g., viewable) area of a display panel to conserve power, along with methods of implementing the same. In some embodiments, for example, when the power saving mode is enabled, the size of the active area of the display panel is reduced, the area outside the active area is deactivated, and frames are rendered and displayed at a lower resolution on the smaller active area of the display panel. In this manner, the display panel consumes less power since only a portion of the entire screen is active, and the graphics processor also consumes less power by rendering frames at a lower resolution. Further, some of the display panel electronics may also be deactivated or powered down when this power saving mode is enabled, such as row and/or column drivers for inactive areas of the screen.

As a result, this power saving mode can be activated to extend the battery life of a client device. In some embodiments, the power saving mode may be automatically activated or triggered under certain conditions, such as when the battery level is low. For example, the active display area may be reduced by certain percentages when the battery level falls below certain thresholds (e.g., 10% screen size reduction for battery level below 30% capacity, 20% screen size reduction for battery level below 20% capacity, etc.). Alternatively, the power saving mode may be manually activated by a user. For example, the user may select a percentage screen size reduction (e.g., 30% reduction), or the user may select a predefined power saving display layout indicating which areas of the screen are active and inactive.

This solution is particularly beneficial for display technologies that provide brightness control at the pixel level, such as OLED and micro-LED, where each pixel of the display panel can be independently controlled or deactivated. In particular, pixel-level brightness control provides a high degree of flexibility as to which areas of the display panel are active or inactive when this power saving mode is enabled.

However, this solution is also beneficial for display technologies that provide brightness control at lower granularities, such as mini-LED, where separate “dimming zones” of the display panel can be independently controlled or deactivated. For example, a mini-LED display panel is a liquid crystal display (LCD) with multiple “dimming zones” powered by separate LED backlights, which enables the brightness of each dimming zone to be independently controlled. In this manner, mini-LED provides control over which dimming zones of the display panel are active or inactive when this power saving mode is enabled.

The described power saving mode provides a unique opportunity to conserve power and extend the battery life of a client device without sacrificing important functionality. In many cases, users may seek to prolong the battery life of a client device, even by a small margin, regardless of whether they are utilizing the full display area. For example, consider a scenario where a user is on a video conference call with a very low (e.g., nearly depleted) battery and no immediate access to a power source. Rather than draining the remaining battery life, the described power saving mode can be enabled (e.g., automatically or manually) to provide a modest extension of battery life at the cost of shrinking the screen size of the display. In this manner, the user can continue participating on the video conference for a longer period of time with a smaller screen size. In these types of scenarios, many users would benefit from a power saving mode that extends battery life at the cost of decreasing the active display area, without sacrificing other important functionality of the client device.

The described embodiments may provide various advantages. For example, the described power saving mode can be used to conserve power and enhance battery life on client devices, without sacrificing key functionality required by users, by reducing the effective display area. The power savings provided by this feature are particularly beneficial for the last-mile charge on a client device, when battery is low and external power sources are unavailable, and continued use of the device with unrestricted functionality is crucial to the user.

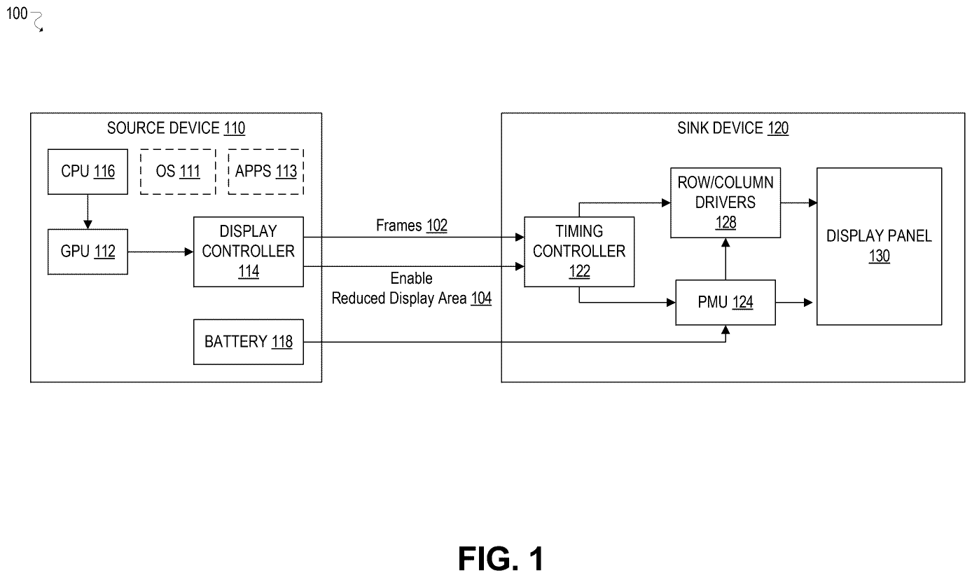

FIG. 1 illustrates an example of a system 100 with a power saving mode that reduces the active area of a display panel 130 to conserve power. In some embodiments, system 100 may be included in a client device. In the illustrated embodiment, system 100 includes a source device 110 and a sink device 120. The source device 110 sends frames 102 (e.g., pixel data for images/video) to the sink device 120 for display, and the sink device 120 process and displays the incoming frames 102 on an associated display panel 130. Moreover, in some cases, the source device 110 may send an instruction 104 to the sink device 120 to enable a power saving mode where the display panel 130 is configured with a reduced active display area. In this manner, the size of the active area of the display panel 130 is scaled down, which conserves power without otherwise limiting the functionality of the system 100, as described further below.

The sink device 120 may be implemented in any display device, meaning any device with a display panel 130, such as a monitor, television, projector, immersive reality headset (e.g., augmented reality (AR) and/or virtual reality (VR)), or embedded-display device such as a mobile device (e.g., laptop, mobile phone, tablet, smart watch). The source device 110 may be implemented in any electronic device or system designed to interface with a sink device 120, such as a computer, mobile device (e.g., laptop, cellular phone, tablet, smart watch), video game console, media player, set-top box, or display device. In various embodiments, the source and sink devices 110, 120 may be implemented in physically separate devices (e.g., a desktop computer as the source device 110 and a monitor as the sink device 120) or integrated within the same device (e.g., a smart television, laptop, mobile phone, tablet, smart watch).

In the illustrated embodiment, the source device 110 includes a central processing unit (CPU) 116, a graphics processing unit (GPU) 112, a display controller 114, and a battery 118. The CPU 116 may execute an operating system (OS) 111 and/or one or more applications 113, which may utilize the GPU 112 for a variety of graphics processing tasks, including processing/display of frames 102 on the display panel 130. The GPU 112 receives image and/or video data (e.g., from CPU 116 or another source) and generates corresponding frame data 102, which represents the image/video data in a format that can be displayed on a display panel 130. The display controller 114 handles synchronization (e.g., horizontal (HSYNC) and vertical (VSYNC) synchronization signals, pixel clocks, refresh rates), frame formatting (e.g., color space, resolution), and transmission of frame data 102 between the source device 110 and the sink device 120. Moreover, the GPU 112 and/or the display controller 114 may store frame data 102 in a frame buffer. The battery 118 may serve as a power source that supplies power to system 100 (e.g., including source device 110 and sink device 120).

In the illustrated embodiment, the sink device 120 includes a timing controller (TCON) 122, a power management unit (PMU) 124, row/column drivers 128, and a display panel 130. The TCON 122 synchronizes the source device 110 and the display panel 130 (e.g., synchronized refresh rates, pixel clocks, HSYNC/VSYNC signals, etc.), receives and decodes incoming frames 102 from the source device 110, and coordinates the display of decoded frames 102 on the display panel 130 (e.g., using row/column drivers 128). The PMU 124 controls the supply and delivery of power (e.g., voltage, current, duty cycle, etc.) to the various components of the sink device 120, including the power needed to drive the display panel 130. The row/column drivers 128 control the rows and columns of the display panel 130. For example, the row drivers 128 (also referred to as gate drivers) control rows of pixels on the display panel 130, and the column drivers 128 (also referred to as source drivers) control columns of pixels on the display panel 130. The display panel 130 is used to display a visual representation of the respective frames 102 based on the coordination from the TCON 122 (e.g., using an array of pixels).

In the illustrated embodiment, the GPU 112 renders frames 102 at a particular resolution for display on the display panel 130 (e.g., based on requests/instructions from, and video data provided by, the OS 111 or applications 113 executing on the CPU 116 or other components). The GPU 112 sends the frames 102 to the display controller 114, which transmits the same to the TCON 122 on the sink device 120. The TCON 122 provides corresponding frame data 102 to the row/column (gate/source) drivers 128, which control the rows and columns of pixels on the display panel 130 to cause the sequence of frames 102 to be displayed on the display panel 130.

The respective components of system 100 are powered by the battery 118 of the source device 110. In some cases, such as when the battery level (e.g., remaining battery capacity) of the battery 118 is low, the source device 110 may send an instruction 104 to the sink device 120 to enable a power saving mode where the display panel 130 is configured with a reduced active display area. In this manner, the size of the active area of the display panel 130 is scaled down, which conserves power without otherwise limiting the functionality of the system 100.

For example, as the battery level falls below progressively lower thresholds of remaining battery capacity, the active display area of the display panel 130 may be automatically reduced by progressively higher percentages (e.g., 10% display reduction for 30% battery capacity, 20% display reduction for 20% battery capacity, 40% display reduction for 10% battery capacity, etc.).

Alternatively, the power saving mode may be manually activated by a user of system 100, causing the corresponding instruction 104 to be sent to the sink device 120. For example, the user may select a percentage screen size reduction (e.g., 20% reduction), or the user may select a predefined display layout indicating which areas of the display panel 130 are active and inactive.

In some embodiments, when the power saving mode is enabled, the TCON 122 may coordinate with the respective components of the sink device 120 (e.g., the row/column drivers 128, PMU 124, and/or display panel 130) to reduce the size of the active viewable area of the display panel 130, deactivate the remaining area of the display panel 130 outside the reduced active area, and instruct the GPU 112 to render frames 102 at a lower resolution suitable for display in the reduced active area of the display panel 130.

The TCON 122 may also (e.g., in coordination with the other components of the sink device 120) deactivate or power down other panel electronics in the sink device 120, such as the row/column drivers 128 for inactive rows or columns of the display panel 130. In some embodiments, the active/inactive regions of the display panel 130 may be aligned with the boundary of row/column (e.g., gate/source) drivers 128 to ensure that the drivers 128 of rows or columns in the inactive region can be completely powered down. In some embodiments, a power gate may be added to the row/column drivers 128 to enable them to be independently powered down.

The inactive area of the display panel 130 (e.g., outside the reduced active area) may be deactivated using any suitable approach, which may depend on the particular display technology used by the display panel 130. In some embodiments, the inactive area may be deactivated by removing or reducing power to that area of the display panel 130. For example, for a display panel 130 with pixel-level control (e.g., OLED, micro-LED), the color of pixels in the inactive area may be darkened or set to black (e.g., effectively deactivating those pixels), and/or power may be removed or reduced to those pixels. As another example, for a display panel 130 with multiple dimming zones (e.g., mini-LED), the backlights for one or more dimming zones in the inactive area may be turned off to deactivate those dimming zones.

In some embodiments, for example, the reduced active area may be centered in the framebuffer (e.g., on the sink device 120), and the surrounding areas or pixels may be darkened or set to black. Alternatively, in some embodiments, the sink device 120 may be implemented with the ability to configure the framebuffer at the new, lower resolution and notify the TCON 122 of the updated resolution. The TCON 122 may then reconfigure the display panel 130 to operate at the new resolution and turn off the inactive areas that are not displaying content.

In this manner, the power consumed by the display panel 130 decreases since only a portion of the entire panel is active, the GPU 112 consumes less power by rendering frames 102 at a lower resolution, and the row/column drivers 128 (and optionally other panel electronics) consume less power since row and column drivers 128 for inactive rows and columns of the display panel 130 are powered down.

A display panel 130 is one the most power-hungry components in a system 100 (e.g., a client device) and is almost always in use. Thus, any reduction in power usage within the display panel 130 can help extend the battery life of the system 100. As a result, this power saving mode can be enabled to extend the battery life of a system 100, when needed, and without sacrificing other essential functionality.

As used herein, the active area of a display panel 130 may also be referred to as the viewable area, display area, effective area, etc. An active area whose size has been scaled down or reduced may be referred to as a reduced active area, reduced viewable area, reduced display area, smaller active area, smaller viewable area, smaller display area, etc. The inactive area of a display panel 130 may also be referred to as a deactivated area. The active area may include one or more contiguous or non-contiguous active areas on a display panel 130, and the inactive area may include one or more contiguous or non-contiguous inactive areas on the display panel 130.

The display panel 130 may include any type of display panel on which information may be displayed, such as a light-emitting diode (LED) display, an organic LED (OLED) display, a micro-LED display, a mini-LED display, a liquid crystal display (LCD), or a display panel based on any other display technology.

System 100, and source/sink devices 110, 120, may be implemented using any type or combination of electronic devices or systems (e.g., integrated circuits, processing units, systems on chip (SoCs), etc.). System 100, source and sink devices 110, 120, and their respective components may be implemented using any type or combination of circuitry, including processing circuitry and/or control circuitry to implement their respective functionality, interface circuitry for communication among the respective components and/or other components (e.g., over a network), etc. Source device 110 and its respective components may be collectively referred to as source circuitry, and sink device 120 and its respective components may be collectively referred to as sink circuitry. In some embodiments, the source/sink devices 110, 120 may be part of an embedded display device (e.g., embedded within the same device and connected to each other via an embedded display port (eDP)).

It should be appreciated that system 100 is merely an example embodiment and numerous other embodiments are also within the scope of this disclosure. In various embodiments, for example, certain components of system 100 may be modified, replaced, rearranged, omitted, and/or added. In some embodiments, the display controller 114 may be integrated as part of the GPU 112. In some embodiments, the source device 110 may include a display engine instead of, or in addition to, a GPU 112 and/or a display controller 114. In some embodiments, system 100 (or source/sink devices 110, 120) may include other or additional components, such as those commonly found in a computing device or system. For example, system 100 (or source/sink devices 110, 120) may include memory, storage devices, communication interfaces, peripheral or input/output (I/O) devices (e.g., keyboard, mouse, speaker, microphone, camera, battery), etc.

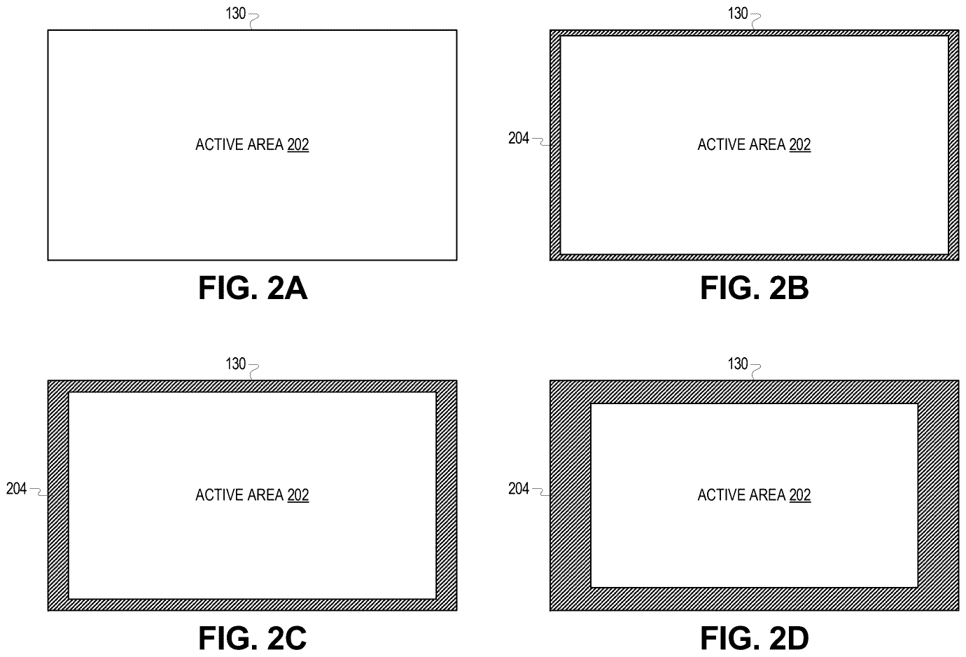

FIGS. 2A-D illustrate examples of a display panel 130 with the active area 202 reduced by various percentages. In the illustrated examples, the active area 202 is reduced by a percentage ranging from 0% to 40%, the resulting active area 202 is centered on the display panel 130, and the remaining areas 204 are deactivated and thus inactive. In this manner, by centering the resulting active area 202, the active area 202 is surrounded on all four sides by an inactive area 204, which is referred to as “windowboxing.” In other embodiments, however, the active area 202 may be scaled down and positioned using other arrangements, including with the active area 202 aligned at the top, bottom, left, or right sides of the display panel 130.

In FIG. 2A, the active area 202 is not reduced (or is reduced by 0%) and takes up the maximum viewable area or screen size supported by the display panel 130. In FIG. 2B, the active area 202 is reduced by 10%, which results in an active area 202 that takes up 90% of the display panel 130 and an inactive area 204 that takes up 10% of the display panel 130. In FIG. 2C, the active area 202 is reduced by 20%, which results in an active area 202 that takes up 80% of the display panel 130 and an inactive area 204 that takes up 20% of the display panel 130. In FIG. 2D, the active area 202 is reduced by 40%, which results in an active area 202 that takes up 60% of the display panel 130 and an inactive area 204 that takes up 40% of the display panel 130.

In some embodiments, the active area 202 of the display panel 130 may be automatically scaled down under certain conditions, such as when the battery level is low. For example, the active area 202 may be automatically reduced by progressively higher percentages as the battery level falls below progressively lower thresholds. In various embodiments, the battery level (e.g., remaining battery capacity) may be estimated using any suitable approach, including based on voltage levels of the battery 118 over time.

As an example, when the battery level is at or above a first threshold (e.g., 30% capacity), the display panel 130 may operate normally with the active area 202 taking up the entire screen, as shown in FIG. 2A. If the battery level falls below the first threshold (e.g., 30% battery capacity), however, the active area 202 may be scaled down to 90% of the maximum screen size, as shown in FIG. 2B. If the battery level falls below a second threshold (e.g., 20% battery capacity), the active area 202 may be scaled down to 80% of the maximum screen size, as shown in FIG. 2C. If the battery level falls below a third critical threshold (e.g., 10% battery capacity), the active area 202 may be scaled down to 60% of the maximum screen size, as shown in FIG. 2D.

For instance, consider a user on a video call using a 16-inch display with a 1080p (1920×1080) resolution. In a low-battery situation, the user may be willing to sacrifice some screen space as long as the call quality (e.g., video resolution, sound quality, latency, network connectivity, etc.) remains unaffected. With the described power saving mode, graphics can be rendered at a slightly reduced resolution, such as 90% of the full size (e.g., 1728×972) or lower, and the display can deactivate the pixels outside this area. This dual approach (e.g., reduced display area and lower frame resolution) can lead to significant power savings, allowing the device to last longer on battery power.

The described power saving mode has the potential to benefit devices with screens of all sizes, but it may have greater impact on devices with larger displays. In particular, in the example with a 16-inch display where the active display area is shrunk to 90% of the maximum screen size, the display panel has the potential for approximately 19% power savings due to the reduced display area, with additional power savings resulting from the reduced graphics rendering workload. If the active display area is reduced even further to 80%, the display panel can potentially achieve around 36% power savings (along with additional savings on the graphics rendering side), thus extending the battery life of the device even longer.

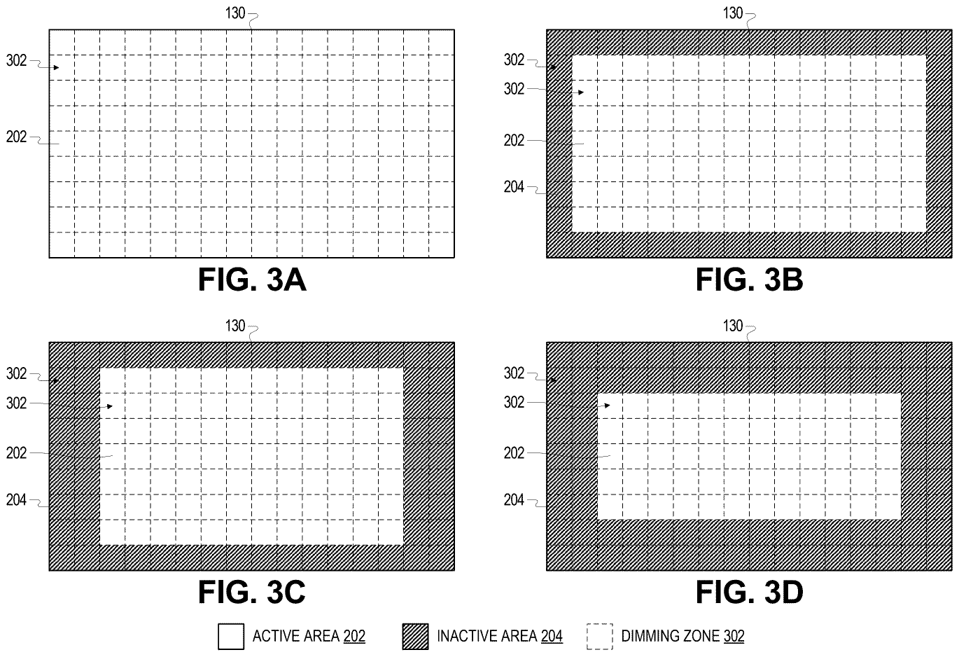

FIGS. 3A-D illustrate examples of a display panel 130 with active and inactive areas 202, 204 defined based on dimming zones 302. In particular, some display panels provide brightness control at a lower granularity than the per-pixel control provided by OLED and micro-LED displays, such as mini-LED displays, where brightness control is provided for separate “dimming zones” 302. A mini-LED display panel is a liquid crystal display (LCD) with multiple dimming zones 302 powered by separate LED backlights, which enables the brightness of each dimming zone 302 to be independently controlled. For example, each dimming zone 302 may be group of contiguous pixels on the display panel 130 powered by their own LED backlight, which enables brightness to be collectively controlled for all pixels in the same dimming zone 302. In this manner, mini-LED enables the active and inactive areas 202, 204 of a display panel 130 to be configured at the dimming zone 302 level.

For example, for a display panel 130 with multiple dimming zones 302 (e.g., mini-LED), the backlights for one or more dimming zones 302 may be turned off to deactivate those dimming zones 302, thus providing control over which dimming zones 302 of the display panel 130 are active 202 or inactive 204 when the power saving mode is enabled.

In the illustrated examples, the display panel 130 is partitioned into a 9×16 array or grid of dimming zones 302, resulting in a total of 144 dimming zones 302. In actual embodiments, the display panel 130 may include any number and arrangement of dimming zones 302, such as around 500 to 2,500 dimming zones 302 for some mini-LED displays.

In FIG. 3A, the active display area 202 includes all dimming zones 302 of the display panel 130, which is the maximum viewable area or screen size supported by the display panel 130. In FIG. 3B, the dimming zones 302 along the edges of the display panel 130 are deactivated, which creates an inactive area 204 along the edges of the display panel 130 that surrounds the active area 202, while also reducing the size of the active area 202. In FIG. 3C, additional columns of dimming zones 302 are deactivated on the left and right sides of the display panel 130, which expands the size of the inactive area 204 and further reduces the size of the active area 202. In FIG. 3D, additional rows of dimming zones 302 are deactivated on the top and bottom of the display panel 130, which once again expands the size of the inactive area 204 and further reduces the size of the active area 202.

In some embodiments, the number or percentage of dimming zones 302 that are deactivated may depend on the battery level, similar to the examples described in connection with FIGS. 2A-D.

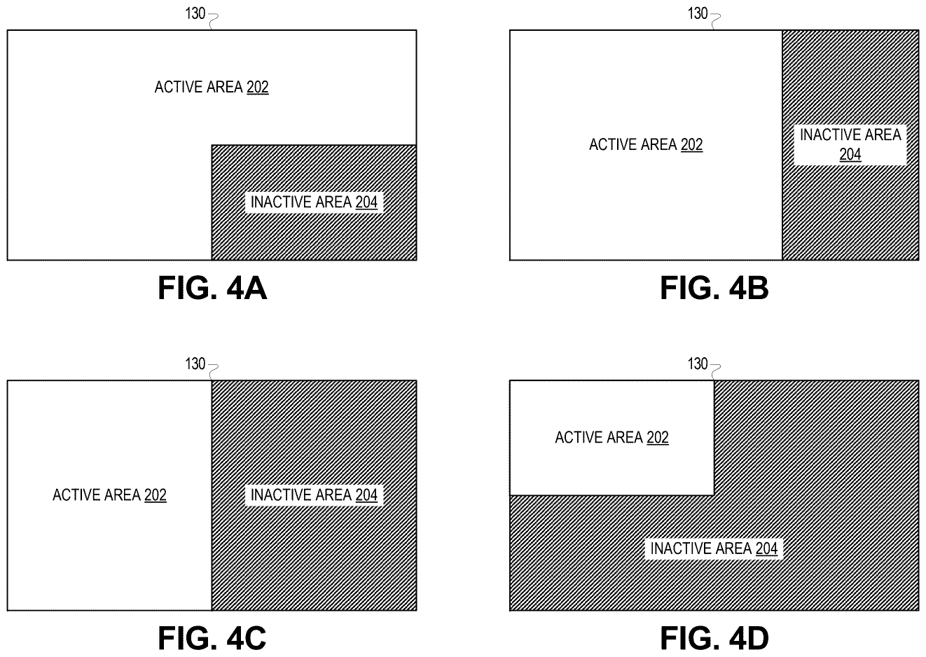

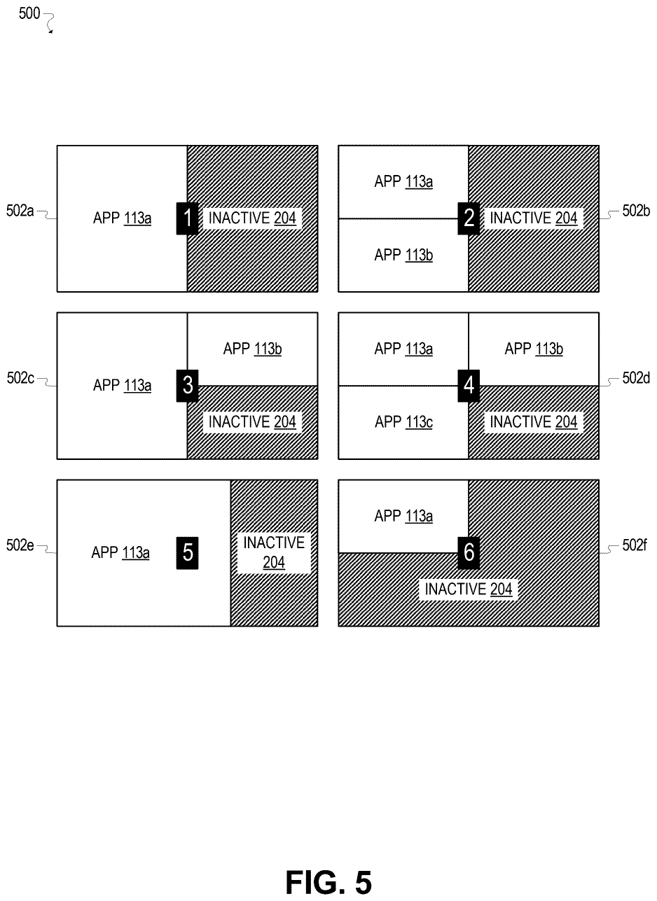

FIGS. 4A-D illustrate examples of a display panel 130 with various alternative arrangements of active areas 202 and inactive areas 204. In FIG. 4A, the active area 202 occupies 75% of the screen and the inactive area 204 occupies 25% of the screen. In FIG. 4B, the active area 202 occupies ˜67% (⅔) of the screen and the inactive area 204 occupies ˜33% (⅓) of the screen. In FIG. 4C, the active area 202 occupies 50% of the screen and the inactive area 204 occupies 50% of the screen. In FIG. 4D, the active area 202 occupies 25% of the screen and the inactive area 204 occupies 75% of the screen. In some embodiments, the arrangements shown in these examples may be used in connection with the power saving display layouts 502a-f shown and described in connection with FIG. 5.

FIG. 5 illustrates an example of a display layout user interface (UI) 500 with preconfigured display layouts 502a-f for reducing the active area of a display panel. In some embodiments, display layout UI 500 may be a graphical interface (e.g., menu or popup) that enables a user to select a desired display layout 502a-f for reducing the active area of the display panel. In this manner, the display panel may then be configured with the selected display layout 502a-f.

In the illustrated example, the display layout UI 500 includes multiple preconfigured display layouts 502a-f containing an arrangement of applications 113 and inactive areas 204, where the applications 113 are mapped to one or more active areas of a display panel and the remaining areas are deemed inactive 204. In the illustrated example, the preconfigured display layouts 502a-f are based on the arrangements of active and inactive areas 202, 204 shown in FIGS. 4A-D.

In layout 502a, application 113a is mapped to half of the screen (50%) and the other half of the screen (50%) is deemed inactive 204. In layout 502 b, applications 113 a,b are each mapped to one-fourth of the screen (25%), thus collectively occupying half of the screen (50%), and the other half of the screen (50%) is deemed inactive 204. In layout 502 c, application 113 a is mapped to half of the screen (50%) and application 113b is mapped to one-fourth of the screen (25%), thus collectively occupying three-fourths of the screen (75%), and the remaining one-fourth of the screen (25%) is deemed inactive 204. In layout 502d, applications 113 a-c are each mapped to one-fourth of the screen (25%), thus collectively occupying three-fourths of the screen (75%), and the remaining one-fourth of the screen (25%) is deemed inactive 204. In layout 502e, application 113a is mapped to two-thirds of the screen (˜67%) and the remaining one-third of the screen (˜33%) is deemed inactive 204. In layout 502f, application 113a is mapped to one-fourth of the screen (25%) and the remaining three-fourths of the screen (75%) is deemed inactive 204.

In some embodiments, the display layout interface 500 may be included as part of the window management/tiling functionality of a graphical user interface and/or operating system, thus enabling the power saving mode with reduced display area to be tailored on a per-application basis. Moreover, in various embodiments, the preconfigured display layouts 502a-f may be manually selected by a user, or they may be automatically selected and configured (e.g., based on battery level, the number and/or type of applications in use, the percentage of time spent by the user in each application, etc.).

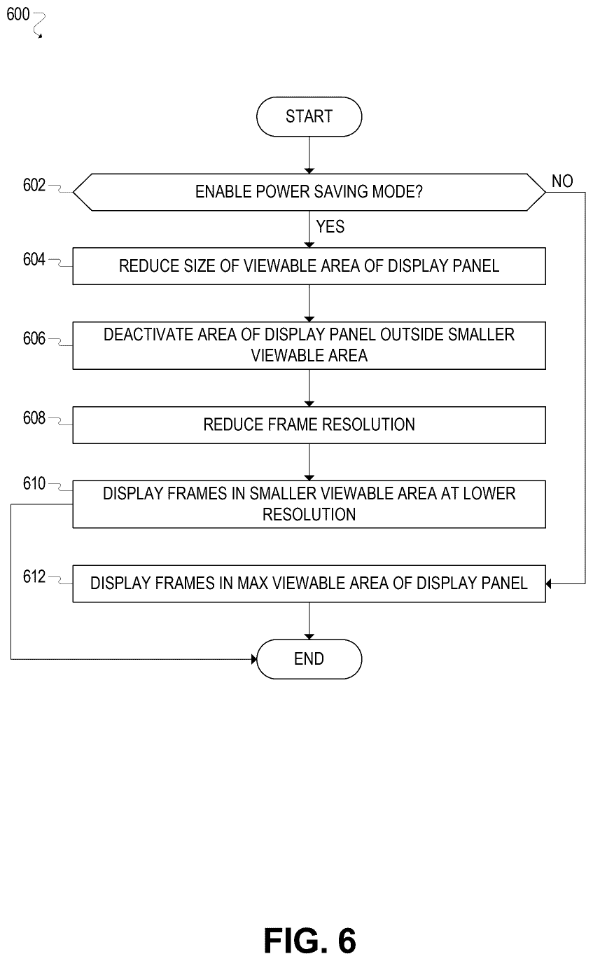

FIG. 6 illustrates an example process flow 600 for reducing the active area of a display panel to conserve power. In some embodiments, the illustrated process flow may be implemented by an electronic device or system, such as system 100.

The process flow begins at block 602 by determining whether to enable a power saving mode on an electronic device (e.g., system 100, a client device, etc.) that reduces the viewable (e.g., active) area of a display panel 130. In some embodiments, the CPU 116 (or the OS 111 or applications 113 executing on the CPU 116) may determine whether to enable the power saving mode. In some embodiments, the power saving mode may be automatically activated or triggered under certain conditions, such as upon determining that the battery level (e.g., of the battery 118) of the electronic device is low (e.g., below a particular threshold). In some embodiments, the power saving mode may be manually activated by a user of the device.

In some embodiments, an instruction 104 to enable the power saving mode (e.g., to reduce the size of the active area of the display panel 130) may be sent from the source device 110 to the sink device 120 (e.g., based on the automatic or manual triggers described above), which may be received by the sink device 120. In some embodiments, the CPU 116 (or the OS 111 or applications 113 executing on the CPU 116) may cause the GPU 112 and/or the display controller 114 to send the instruction 104 to the timing controller 122.

If the power saving mode is not enabled at block 602, the process flow proceeds to block 612 to display frames 102 in the maximum viewable area (e.g., full screen) of the display panel 130.

If the power saving mode is enabled at block 602, the process flow proceeds to block 604 to reduce the size of the viewable (e.g., active) area of the display panel 130. As a result, the viewable area of the display panel 130 becomes a smaller viewable (e.g., active) area. In some embodiments, the size of the viewable area may be reduced by the timing controller 122, the row/column drivers 128, and/or the PMU 124.

In some embodiments, the size of the viewable area may be reduced by a percentage (e.g., a percentage of the maximum viewable area of the display panel 130). In some embodiments, the percentage reduction may depend on how low the battery level is. For example, the viewable area may be automatically reduced by higher percentages as the battery level decreases below certain thresholds. In some embodiments, a user may manually select a particular percentage for reducing the size of the viewable area.

In some embodiments, the size of the viewable area may be reduced based on a power saving display layout (e.g., layouts 502a-f) indicating which areas of the screen should be active and inactive, and optionally which applications 113 should be positioned in the active areas. For example, the display layout may indicate an arrangement or mapping of one or more active areas of the display panel 130 and one or more inactive areas of the display panel 130, and optionally one or more applications 113 to position in the active areas. In some embodiments, a user may select the display layout from a menu or user interface with multiple preconfigured display layouts (e.g., display layout interface 500 with layouts 502a-f). In some embodiments, the instruction 104 to reduce the size of the active area of the display panel 130 may indicate the arrangement of active areas and inactive areas identified in the selected display layout. The display panel 130 may then be configured based on the selected display layout (e.g., using the particular arrangement of active areas, inactive areas, and applications mapped to the respective active areas).

The process flow then proceeds to block 606 to deactivate the area of the display panel 130 outside the smaller or reduced viewable area. As a result, the area of the display panel 130 outside the smaller viewable area becomes a deactivated area, or inactive area, of the display panel 130. In this manner, the display panel 130 consumes less power due to the smaller viewable area and the deactivated area. In some embodiments, the area of the display panel 130 outside the smaller viewable area may be deactivated by the timing controller 122, the row/column drivers 128, and/or the PMU 124.

In some embodiments, the area outside the smaller active area may be deactivated by removing or reducing power to that area of the display panel 130. For example, for a display panel 130 with pixel-level control (e.g., OLED, micro-LED), the color of pixels outside the smaller viewable area may be set to black (e.g., effectively deactivating those pixels), and/or power may be removed or reduced to those pixels. As another example, for a display panel 130 with multiple dimming zones (e.g., mini-LED), the backlights for one or more dimming zones outside the smaller viewable area may be turned off to deactivate those dimming zones.

In some embodiments, one or more row and/or column drivers 128 of the display panel 130 may also be deactivated for any full rows or columns in the deactivated area of the display panel 130 (e.g., outside the smaller viewable area). For example, row drivers for any full rows of pixels in the deactivated area may be deactivated or powered down. Similarly, column drivers for any full columns of pixels in the deactivated area may be deactivated or powered down. In some embodiments, the appropriate row/column drivers 128 may be deactivated or powered down by the timing controller 122 and/or the PMU 124.

The process flow then proceeds to block 608 to reduce the resolution of frames 102 rendered for display on the display panel 130. In some embodiments, for example, the GPU 112 may render frames 102 at a lower resolution when the power saving mode is enabled. The particular resolution may vary depending on the size of the smaller viewable area of the display panel 130.

The process flow then proceeds to block 610 to display frames 102 in the smaller active area of the display panel 130 at the lower resolution. In some embodiments, the lower resolution frames 102 may be sent from the GPU 112 to the display controller 114, and then from the display controller 114 to the timing controller 122. The timing controller 122 may then cause the lower resolution frames 102 to be displayed in the smaller active area of the display panel 130 (e.g., using the row/column drivers 128).

At this point, the process flow may be complete. In some embodiments, however, the process flow may restart at block 602 to continue processing and display frames (e.g., with the power saving mode enabled or disabled).

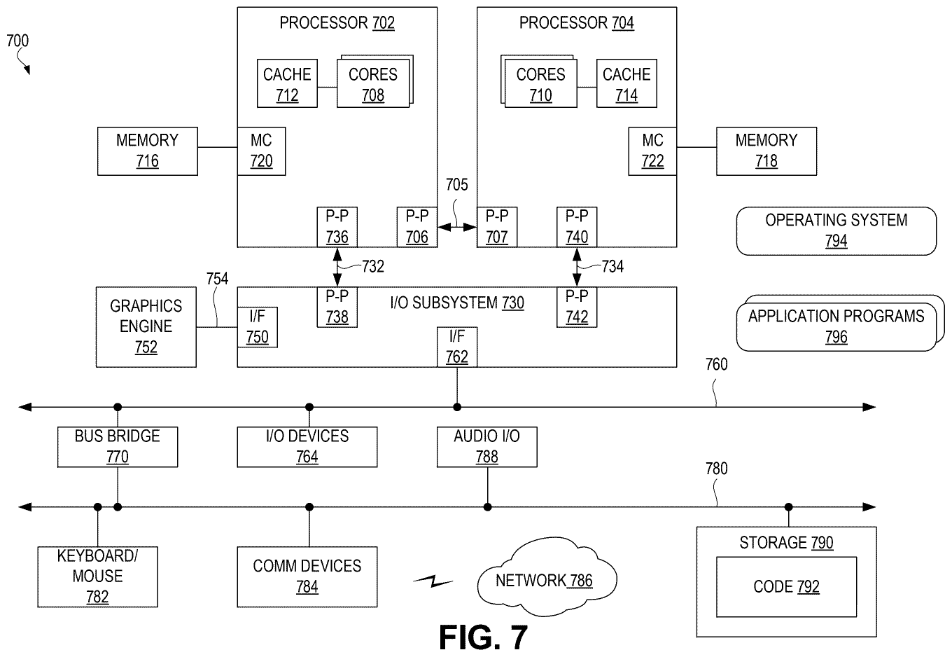

FIG. 7 illustrates an example computing system 700 in which technologies described herein may be implemented. In some embodiments, for example, system 700 may be used to implement system 100, processor 702, 704 may include CPU 116 and/or GPU 112, graphics engine 752 may include GPU 112 and/or display controller 114, and I/O devices 764 may include a display device (e.g., sink device 120 and associated display panel 130).

Generally, components shown in FIG. 7 can communicate with other shown components, although not all connections are shown, for ease of illustration. The computing system 700 is a multiprocessor system comprising first processor unit 702 and second processor unit 704 comprising point-to-point (P-P) interconnects. A point-to-point (P-P) interface 706 of the first processor unit 702 is coupled to a point-to-point interface 707 of the second processor unit 704 via a point-to-point interconnection 705. It is to be understood that any or all of the point-to-point interconnects illustrated in FIG. 7 can be alternatively implemented as a multi-drop bus, and that any or all buses illustrated in FIG. 7 could be replaced by point-to-point interconnects.

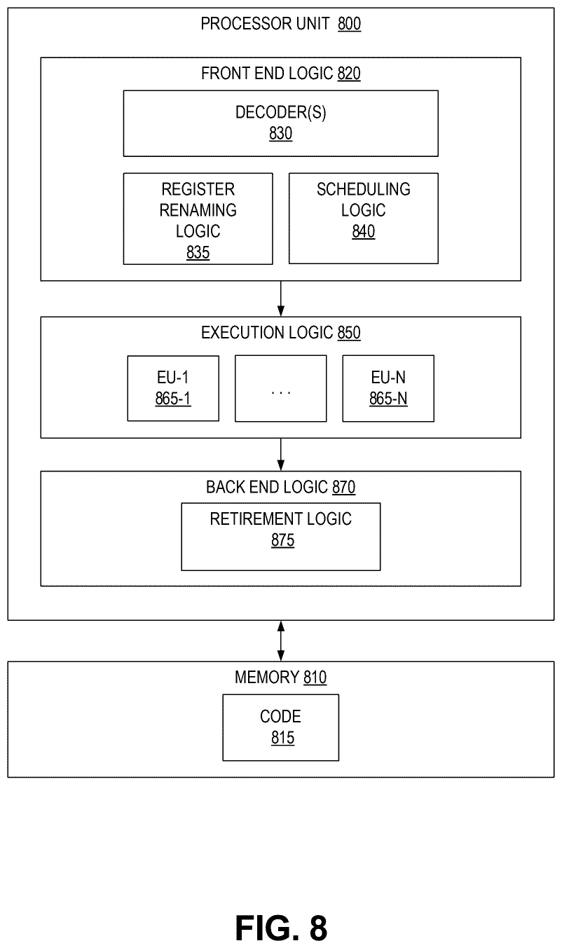

The first processor unit 702 and second processor unit 704 comprise multiple processor cores. The first processor unit 702 comprises processor cores 708 and the second processor unit 704 comprises processor cores 710. Processor cores 708 and 710 can execute computer-executable instructions in a manner similar to that discussed below in connection with FIG. 8, or other manners.

The first processor unit 702 and the second processor unit 704 further comprise cache memories 712 and 714, respectively. The cache memories 712 and 714 can store data (e.g., instructions) utilized by one or more components of the first processor unit 702 and the second processor unit 704, such as the processor cores 708 and 710. The cache memories 712 and 714 can be part of a memory hierarchy for the computing system 700. For example, the cache memories 712 can locally store data that is also stored in a first memory 716 to allow for faster access to the data by the first processor unit 702. In some embodiments, the cache memories 712 and 714 can comprise multiple cache memories that are a part of a memory hierarchy. The cache memories in the memory hierarchy can be at different cache memory levels, such as level 1(L1 ), level 2(L2 ), level 3(L 3 ), level 4(L 4 ), or other cache memory levels. In some embodiments, one or more levels of cache memory (e.g., L2, L3, L4) can be shared among multiple cores in a processor unit or among multiple processor units in an integrated circuit component. In some embodiments, the last level of cache memory in an integrated circuit component can be referred to as a last-level cache (LLC). One or more of the higher levels of cache levels (the smaller and faster cache memories) in the memory hierarchy can be located on the same integrated circuit die as a processor core and one or more of the lower cache levels (the larger and slower caches) can be located on one or more integrated circuit dies that are physically separate from the processor core integrated circuit dies.

Although the computing system 700 is shown with two processor units, the computing system 700 can comprise any number of processor units. Further, a processor unit can comprise any number of processor cores. A processor unit can take various forms such as a central processing unit (CPU), graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other type of processing unit. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 700 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The first processor unit 702 and the second processor unit 704 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from any integrated circuit die containing a processor unit. In some embodiments, these separate integrated circuit dies can be referred to as “chiplets”. In some embodiments, where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by a package substrate, one or more silicon interposers, one or more silicon bridges embedded in a package substrate (such as Intel® embedded multi-die interconnect bridges (EMIBs)), or combinations thereof.

The first processor unit 702 further comprises first memory controller logic (first MC 720) and the second processor unit 704 further comprises second memory controller logic (second MC 722). As shown in FIG. 7, a first memory 716 coupled to the first processor unit 702 is controlled by the first MC 720 and a second memory 718 coupled to the second processor unit 704 is controlled by the second MC 722. The first memory 716 and the second memory 718 can comprise various types of volatile memory (e.g., dynamic random-access memory (DRAM), static random-access memory (SRAM)) and/or non-volatile memory (e.g., flash memory, chalcogenide-based phase-change non-volatile memories). The first memory 716 and the second memory 718 can comprise one or more layers of a memory hierarchy of the computing system. While first MC 720 and second MC 722 are illustrated as being integrated into the first processor unit 702 and the second processor unit 704, in alternative embodiments, memory controller logic can be external to a processor unit.

The first processor unit 702 and the second processor unit 704 are coupled to an Input/Output subsystem 730 (I/O subsystem) via point-to-point interconnections 732 and 734. The point-to-point interconnection 732 connects a point-to-point interface 736 of the first processor unit 702 with a point-to-point interface 738 of the Input/Output subsystem 730, and the point-to-point interconnection 734 connects a point-to-point interface 740 of the second processor unit 704 with a point-to-point interface 742 of the Input/Output subsystem 730. Input/Output subsystem 730 further includes an interface 750 to couple the Input/Output subsystem 730 to a graphics engine 752. The Input/Output subsystem 730 and the graphics engine 752 are coupled via a bus 754.

The Input/Output subsystem 730 is further coupled to a first bus 760 via an interface 762. The first bus 760 can be a Peripheral Component Interconnect Express (PCIe) bus or any other type of bus. Various I/O devices 764 can be coupled to the first bus 760. A bus bridge 770 can couple the first bus 760 to a second bus 780. In some embodiments, the second bus 780 can be a low pin count (LPC) bus. Various devices can be coupled to the second bus 780 including, for example, a keyboard/mouse 782, audio I/O devices 788, and a storage device 790, such as a hard disk drive, solid-state drive, or another storage device for storing computer-executable instructions (or code 792) or data. The code 792 can comprise computer-executable instructions for performing methods described herein. Additional components that can be coupled to the second bus 780 include one or more communication devices 784, which can provide for communication between the computing system 700 and one or more wired or wireless networks 786 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 502.11 standard and its supplements).

In embodiments where the one or more communication devices 784 support wireless communication, the one or more communication devices 784 can comprise wireless communication components coupled to one or more antennas to support communication between the computing system 700 and external devices. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The computing system 700 can comprise removable memory such as flash memory cards (e.g., SD (Secure Digital) cards), memory sticks, Subscriber Identity Module (SIM) cards). The memory in computing system 700 (including cache memories 712 and 714, first memory 716, second memory 718, and storage device 790) can store data and/or computer-executable instructions for executing an operating system 794 and application programs 796. Example data includes web pages, text messages, images, sound files, and video data, to be sent to and/or received from one or more network servers or other devices by the computing system 700 via the one or more wired or wireless networks 786, or for use by the computing system 700. The computing system 700 can also have access to external memory or storage (not shown) such as external hard drives or cloud-based storage.

The operating system 794 can control the allocation and usage of the components illustrated in FIG. 7 and support the application programs 796. The application programs 796 can include common computing system applications (e.g., email applications, calendars, contact managers, web browsers, messaging applications) as well as other computing applications, such as multimedia applications (e.g., for video playback/streaming).

In some embodiments, a hypervisor (or virtual machine manager) operates on the operating system 794 and the application programs 796 operate within one or more virtual machines operating on the hypervisor. In these embodiments, the hypervisor is a type-2 or hosted hypervisor as it is running on the operating system 794. In other hypervisor-based embodiments, the hypervisor is a type-1 or “bare-metal” hypervisor that runs directly on the platform resources of the computing system 700 without an intervening operating system layer.

In some embodiments, the application programs 796 can operate within one or more containers. A container is a running instance of a container image, which is a package of binary images for one or more of the application programs 796 and any libraries, configuration settings, and any other information that the application programs 796 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 794. An orchestrator can be responsible for management of the computing system 700 and various container-related tasks such as deploying container images to the computing system 700, monitoring the performance of deployed containers, and monitoring the utilization of the resources of the computing system 700.

The computing system 700 can support various additional input devices 764, such as a touchscreen, microphone, monoscopic camera, stereoscopic camera, trackball, touchpad, trackpad, proximity sensor, light sensor, electrocardiogram (ECG) sensor, PPG (photoplethysmogram) sensor, galvanic skin response sensor, and one or more output devices 764, such as one or more speakers or displays. Other possible input and output devices 764 include piezoelectric and other haptic I/O devices. Any of the input or output devices can be internal to, external to, or removably attachable with the computing system 700. External input and output devices can communicate with the computing system 700 via wired or wireless connections.

In addition, the computing system 700 can provide one or more natural user interfaces (NUIs). For example, the operating system 794 or application programs 796 can comprise speech recognition logic as part of a voice user interface that allows a user to operate the computing system 700 via voice commands. Further, the computing system 700 can comprise input devices and logic that allows a user to interact with computing the computing system 700 via body, hand, or face gestures.

The computing system 700 can further include at least one input/output port comprising physical connectors (e.g., USB, FireWire, Ethernet, RS-232), a power supply (e.g., battery), a global satellite navigation system (GNSS) receiver (e.g., GPS receiver); a gyroscope; an accelerometer; and/or a compass. A GNSS receiver can be coupled to a GNSS antenna. The computing system 700 can further comprise one or more additional antennas coupled to one or more additional receivers, transmitters, and/or transceivers to enable additional functions.

In addition to those already discussed, integrated circuit components, integrated circuit constituent components, and other components in the computing system 700 can communicate via interconnect technologies such as Intel® QuickPath Interconnect (QPI), Intel® Ultra Path Interconnect (UPI), Computer Express Link (CXL), cache coherent interconnect for accelerators (CCIX®), serializer/deserializer (SERDES), Nvidia® NVLink, ARM Infinity Link, Gen-Z, or Open Coherent Accelerator Processor Interface (OpenCAPI). Other interconnect technologies may be used and a computing system 700 may utilize more or more interconnect technologies.

It is to be understood that FIG. 7 illustrates only one example computing system architecture. Computing systems based on alternative architectures can be used to implement technologies described herein. For example, instead of the first processor unit 702, the second processor unit 704, and the graphics engine 752 being located on discrete integrated circuit dies, a computing system can comprise an SoC (system-on-a-chip) integrated circuit die on which multiple processors, a graphics engine, and additional components are incorporated. Further, a computing system can connect its constituent component via bus or point-to-point configurations different from that shown in FIG. 7. Moreover, the illustrated components in FIG. 7 are not required or all-inclusive, as shown components can be removed and other components added in alternative embodiments.

FIG. 8 illustrates an example processor unit 800 to execute computer-executable instructions as part of implementing technologies described herein. In some embodiments, for example, processor unit 800 may include CPU 116 and/or GPU 112.

The processor unit 800 can be a single-threaded core or a multithreaded core in that it may include more than one hardware thread context (or “logical processor”) per processor unit.

FIG. 8 also illustrates a memory 810 coupled to the processor unit 800. The memory 810 can be any memory described herein or any other memory known to those of skill in the art. The memory 810 can store computer-executable instructions 815 (code) executable by the processor unit 800.

The processor unit comprises front-end logic 820 that receives instructions from the memory 810. An instruction can be processed by one or more decoders 830. The one or more decoders 830 can generate as its output a micro-operation such as a fixed width micro-operation in a predefined format, or generate other instructions, microinstructions, or control signals, which reflect the original code instruction. The front-end logic 820 further comprises register renaming logic 835 and scheduling logic 840, which generally allocate resources and queues operations corresponding to converting an instruction for execution.

The processor unit 800 further comprises execution logic 850, which comprises one or more execution units (EUs) (execution unit 865-1 through execution unit 865-N). Some processor unit embodiments can include a number of execution units dedicated to specific functions or sets of functions. Other embodiments can include only one execution unit or one execution unit that can perform a particular function. The execution logic 850 performs the operations specified by code instructions. After completion of execution of the operations specified by the code instructions, back-end logic 870 retires instructions using retirement logic 875. In some embodiments, the processor unit 800 allows out of order execution but requires in-order retirement of instructions. Retirement logic 875 can take a variety of forms as known to those of skill in the art (e.g., re-order buffers or the like).

The processor unit 800 is transformed during execution of instructions, at least in terms of the output generated by the one or more decoders 830, hardware registers and tables utilized by the register renaming logic 835, and any registers (not shown) modified by the execution logic 850.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

The concepts described herein are illustrated by way of example and not by way of limitation in the accompanying drawings. For simplicity and clarity of illustration, elements illustrated in the drawings are not necessarily drawn to scale. Where considered appropriate, reference labels have been repeated among the drawings to indicate corresponding or analogous elements.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative drawings. Additionally, the inclusion of a structural or method feature in a particular drawing is not meant to imply that such feature is required in all embodiments and, in some embodiments, may not be included or may be combined with other features.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

A list of items joined by the term “and/or” can mean any combination of the listed items. For example, the phrase “A, B and/or C” can mean A; B; C; A and B; A and C; B and C; or A, B and C. A list of items joined by the term “at least one of” can mean any combination of the listed terms. For example, the phrase “at least one of A, B or C” can mean A; B; C; A and B; A and C; B and C; or A, B, and C. Moreover, a list of items joined by the term “one or more of” can mean any combination of the listed terms. For example, the phrase “one or more of A, B and C” can mean A; B; C; A and B; A and C; B and C; or A, B, and C.

The technologies described herein can be performed by or implemented in any of a variety of computing systems, including mobile computing systems (e.g., smartphones, handheld computers, tablet computers, laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, or multiple machine-readable storage media, which may be read and executed by one or more machines (e.g., computers, processors, etc.). A machine-readable storage medium may be embodied as any storage device, mechanism, or other physical structure for storing or transmitting information in a form readable by a machine (e.g., a volatile or non-volatile memory, a media disc, or other media device).

### EXAMPLES

The following examples pertain to embodiments of technologies disclosed herein.

Example 1 includes an electronic device, comprising: a display panel; and processing circuitry to: reduce a size of a viewable area of the display panel; and deactivate an area of the display panel outside the viewable area to form a deactivated area of the display panel, wherein power consumed by the display panel decreases based on the deactivated area.

Example 2 includes the electronic device of Example 1, wherein the processing circuitry to deactivate the area of the display panel outside the viewable area is further to: deactivate pixels outside the viewable area to form deactivated pixels, wherein power consumed by the display panel decreases based on the deactivated pixels.

Example 3 includes the electronic device of Example 2, wherein the processing circuitry to deactivate the pixels outside the viewable area is further to: remove power to the pixels outside the viewable area; reduce power to the pixels outside the viewable area; or set a color of the pixels outside the viewable area to black.

Example 4 includes the electronic device of any one of Examples 2-3, wherein the display panel is an organic light-emitting diode (OLED) display panel or a micro light-emitting diode (micro-LED) display panel.

Example 5 includes the electronic device of Example 1, wherein: the display panel comprises a plurality of dimming zones, wherein the plurality of dimming zones are controlled by a plurality of backlights; and the processing circuitry to deactivate the area of the display panel outside the viewable area is further to: turn off one or more backlights for one or more dimming zones of the display panel, wherein the one or more dimming zones are outside the viewable area of the display panel.

Example 6 includes the electronic device of Example 5, wherein the display panel is a mini light-emitting diode (mini-LED) display panel.

Example 7 includes the electronic device of any one of Examples 1-6, wherein the processing circuitry to deactivate the area of the display panel outside the viewable area is further to: deactivate one or more row drivers of the display panel, wherein the one or more row drivers control one or more rows of the display panel, wherein the one or more rows are within the deactivated area; or deactivate one or more column drivers of the display panel, wherein the one or more column drivers control one or more columns of the display panel, wherein the one or more columns are within the deactivated area.

Example 8 includes the electronic device of any one of Examples 1-7, wherein the processing circuitry is further to, before reducing the size of the viewable area of the display panel and deactivating the area of the display panel outside the viewable area: determine that a battery level of the electronic device is below a threshold.

Example 9 includes the electronic device of any one of Examples 1-8, wherein the processing circuitry is further to, before reducing the size of the viewable area of the display panel and deactivating the area of the display panel outside the viewable area: receive an instruction to reduce the size of the size of the viewable area of the display panel.

Example 10 includes the electronic device of any one of Examples 1-9, wherein the processing circuitry to reduce the size of the viewable area of the display panel is further to: reduce the size of the viewable area to a percentage of a maximum viewable area of the display panel.

Example 11 includes the electronic device of any one of Examples 1-10, wherein the processing circuitry to reduce the size of the viewable area of the display panel is further to: reduce a resolution of frames to be displayed in the viewable area of the display panel.

Example 12 includes the electronic device of Example 11, wherein the processing circuitry is further to cause the frames to be displayed in the viewable area of the display panel at the reduced resolution.

Example 13 includes the electronic device of any one of Examples 1-12, wherein the processing circuitry is further to: configure the display panel based on a display layout, wherein the display layout indicates an arrangement of one or more active areas of the display panel and one or more inactive areas of the display panel, wherein the viewable area comprises the one or more active areas, and wherein the deactivated area comprises the one or more inactive areas.

Example 14 includes the electronic device of Example 13, wherein the display layout is selected, by a user, from a plurality of display layouts.

Example 15 includes the electronic device of any one of Examples 1-14, wherein the processing circuitry comprises one or more of a central processing unit, a graphics processing unit, or a display timing controller.

Example 16 includes a system, comprising: source circuitry to send, to a sink circuitry, an instruction to reduce a size of an active area of a display panel; and the sink circuitry to: receive, from the source circuitry, the instruction to reduce the size of the active area of the display panel; and based on receiving the instruction, reduce the size of the active area of the display panel to form a smaller active area, wherein an area of the display panel outside the smaller active area becomes an inactive area of the display panel, and wherein the display panel consumes less power based on reducing the size of the active area.

Example 17 includes the system of Example 16, wherein the source circuitry is further to, before sending the instruction to reduce the size of the active area of the display panel: determine that a battery level of the system is below a threshold.

Example 18 includes the system of any one of Examples 16-17, wherein: the source circuitry is further to send, to the sink circuitry, a plurality of frames to be displayed in the smaller active area of the display panel; and the sink circuitry is further to: receive, from the source circuitry, the plurality of frames; and cause the plurality of frames to be displayed in the smaller active area of the display panel.

Example 19 includes the system of any one of Examples 16-18, wherein: the source circuitry comprises a display controller, wherein the display controller is to send, to a timing controller, the instruction to reduce the size of the active area of the display panel; and the sink circuitry comprises the timing controller, wherein the timing controller is to cause the size of the active area of the display panel to be reduced.

Example 20 includes the system of Example 19, wherein the sink circuitry further comprises a power management unit (PMU), wherein the PMU is to: remove power to the area of the display panel outside the smaller active area; or reduce power to the area of the display panel outside the smaller active area.

Example 21 includes the system of any one of Examples 16-20, wherein the source circuitry further comprises a graphics processing unit (GPU), wherein the GPU is to reduce a resolution of frames displayed in the smaller active area.

Example 22 includes the system of any one of Examples 16-21, wherein the sink circuitry to reduce the size of the active area of the display panel is further to: remove power to pixels in the inactive area; reduce power to the pixels in the inactive area; or set a color of the pixels in the inactive area to black.

Example 23 includes the system of any one of Examples 16-21, wherein the sink circuitry to reduce the size of the active area of the display panel is further to: turn off one or more backlights for one or more dimming zones of the display panel, wherein the one or more dimming zones are outside the smaller active area of the display panel.

Example 24 includes the system of any one of Examples 16-23, wherein the sink circuitry to reduce the size of the active area of the display panel is further to: deactivate one or more row drivers of the display panel, wherein the one or more row drivers control one or more rows of the display panel, wherein the one or more rows are within the inactive area; or deactivate one or more column drivers of the display panel, wherein the one or more column drivers control one or more columns of the display panel, wherein the one or more columns are within the inactive area.

Example 25 includes the system of any one of Examples 16-24, wherein the sink circuitry to reduce the size of the active area of the display panel is further to: reduce the size of the active area by a percentage.

Example 26 includes the system of any one of Examples 16-24, wherein: the smaller active area is to comprise one or more active areas of the display panel; the inactive area is to comprise one or more inactive areas of the display panel; and the instruction to reduce the size of the active area of the display panel is further to indicate an arrangement of the one or more active areas and the one or more inactive areas.

Example 27 includes a method, comprising: receiving an instruction to reduce a size of an active area of a display panel; and based on the instruction, reducing the size of the active area of the display panel, wherein the active area becomes a smaller active area, wherein an area of the display panel outside the smaller active area becomes an inactive area of the display panel, and wherein the display panel consumes less power based on reducing the size of the active area.

Example 28 includes the method of Example 27, further comprising, before receiving the instruction to reduce the size of the active area of the display panel: determining that a battery level is below a threshold.

Example 29 includes the method of any one of Examples 27-28, further comprising: receiving a plurality of frames; and causing the plurality of frames to be displayed in the smaller active area of the display panel.

Example 30 includes the method of Example 29, wherein reducing the size of the active area of the display panel comprises: reducing a resolution of the plurality of frames displayed in the smaller active area.

Example 31 includes the method of any one of Examples 27-30, wherein reducing the size of the active area of the display panel comprises: removing power to pixels in the inactive area; reducing power to the pixels in the inactive area; or setting a color of the pixels in the inactive area to black.

Example 32 includes the method of any one of Examples 27-30, wherein reducing the size of the active area of the display panel comprises: turning off one or more backlights for one or more dimming zones of the display panel, wherein the one or more dimming zones are outside the smaller active area of the display panel.

Example 33 includes the method of any one of Examples 27-32, wherein reducing the size of the active area of the display panel comprises: deactivating one or more row drivers of the display panel, wherein the one or more row drivers control one or more rows of the display panel, wherein the one or more rows are within the inactive area; or deactivating one or more column drivers of the display panel, wherein the one or more column drivers control one or more columns of the display panel, wherein the one or more columns are within the inactive area.

Example 34 includes the method of any one of Examples 27-33, wherein reducing the size of the active area of the display panel comprises: reducing the size of the active area by a percentage.

Example 35 includes the method of any one of Examples 27-33, wherein: the smaller active area is to comprise one or more active areas of the display panel; the inactive area is to comprise one or more inactive areas of the display panel; and the instruction to reduce the size of the active area of the display panel is further to indicate an arrangement of the one or more active areas and the one or more inactive areas.

Example 36 includes one or more computer-readable storage media storing computer-executable instructions that, when executed, cause a computer to perform a method, the method comprising: receiving an instruction to reduce a size of an active area of a display panel; and based on the instruction, reducing the size of the active area of the display panel, wherein the active area becomes a smaller active area, wherein an area of the display panel outside the smaller active area becomes an inactive area of the display panel, and wherein the display panel consumes less power based on reducing the size of the active area.

Example 37 includes the one or more computer-readable storage media of Example 36, further comprising, before receiving the instruction to reduce the size of the active area of the display panel: determining that a battery level is below a threshold.

Example 38 includes the one or more computer-readable storage media of any one of Examples 36-37, further comprising: receiving a plurality of frames; and causing the plurality of frames to be displayed in the smaller active area of the display panel.

Example 39 includes the one or more computer-readable storage media of Example 38, further comprising: reducing a resolution of the plurality of frames displayed in the smaller active area.

Example 40 includes the one or more computer-readable storage media of any one of Examples 36-39, wherein reducing the size of the active area of the display panel comprises: removing power to pixels in the inactive area; reducing power to the pixels in the inactive area; or setting a color of the pixels in the inactive area to black.

Example 41 includes the one or more computer-readable storage media of any one of Examples 36-39, wherein reducing the size of the active area of the display panel comprises: turning off one or more backlights for one or more dimming zones of the display panel, wherein the one or more dimming zones are outside the smaller active area of the display panel.

Example 42 includes the one or more computer-readable storage media of any one of Examples 36-41, wherein reducing the size of the active area of the display panel comprises: deactivating one or more row drivers of the display panel, wherein the one or more row drivers control one or more rows of the display panel, wherein the one or more rows are within the inactive area; or deactivating one or more column drivers of the display panel, wherein the one or more column drivers control one or more columns of the display panel, wherein the one or more columns are within the inactive area.

Example 43 includes the one or more computer-readable storage media of any one of Examples 36-42, wherein reducing the size of the active area of the display panel comprises: reducing the size of the active area by a percentage.

Example 44 includes the one or more computer-readable storage media of any one of Examples 36-42, wherein: the smaller active area is to comprise one or more active areas of the display panel; the inactive area is to comprise one or more inactive areas of the display panel; and the instruction to reduce the size of the active area of the display panel is further to indicate an arrangement of the one or more active areas and the one or more inactive areas.

Example 45 includes the electronic device of any one of Examples 1-15, wherein the electronic device is a client device.

Examples 46 includes the system of any one of Examples 16-26, wherein the system is comprised in a client device.

Example 47 includes one or more computer-readable storage media storing computer-executable instructions that, when executed, cause a computer to perform the method of any one of Examples 27-35.

Example 48 includes an apparatus comprising means to perform the method of any one of Examples 27-35.

Example 49 includes a system comprising means to perform the method of any one of Examples 27-35.

1. An electronic device, comprising:
a display panel; and
processing circuitry to:
reduce a size of a viewable area of the display panel, wherein the viewable area becomes a smaller viewable area;
deactivate an area of the display panel outside the smaller viewable area to form a deactivated area of the display panel, wherein power consumed by the display panel decreases based on the deactivated area;
render frames at a reduced resolution, wherein the reduced resolution corresponds to the smaller viewable area of the display panel; and
cause the frames to be displayed in the smaller viewable area of the display panel at the reduced resolution.

2. The electronic device of claim 1, wherein the processing circuitry to deactivate the area of the display panel outside the smaller viewable area is further to:
deactivate pixels outside the smaller viewable area to form deactivated pixels, wherein power consumed by the display panel decreases based on the deactivated pixels.

3. The electronic device of claim 2, wherein the processing circuitry to deactivate the pixels outside the smaller viewable area is further to:
remove power to the pixels outside the smaller viewable area;
reduce power to the pixels outside the smaller viewable area; or
set a color of the pixels outside the smaller viewable area to black.

4. The electronic device of claim 2, wherein the display panel is an organic light-emitting diode (OLED) display panel or a micro light-emitting diode (micro-LED) display panel.

5. The electronic device of claim 1, wherein:
the display panel comprises a plurality of dimming zones, wherein the plurality of dimming zones are controlled by a plurality of backlights; and
the processing circuitry to deactivate the area of the display panel outside the smaller viewable area is further to:
turn off one or more backlights for one or more dimming zones of the display panel, wherein the one or more dimming zones are outside the smaller viewable area of the display panel.

6. The electronic device of claim 5, wherein the display panel is a mini light-emitting diode (mini-LED) display panel.

7. The electronic device of claim 1, wherein the processing circuitry is further to, before reducing the size of the viewable area of the display panel and deactivating the area of the display panel outside the smaller viewable area:
determine that a battery level of the electronic device is below a threshold.

8. The electronic device of claim 1, wherein the processing circuitry to reduce the size of the viewable area of the display panel is further to:
reduce the size of the viewable area to a percentage of a maximum viewable area of the display panel.

9. (canceled)

10. The electronic device of claim 1, wherein the processing circuitry is further to:
configure the display panel based on a display layout, wherein the display layout indicates an arrangement of one or more active areas of the display panel and one or more inactive areas of the display panel, wherein the smaller viewable area comprises the one or more active areas, and wherein the deactivated area comprises the one or more inactive areas.

11. A system, comprising:
source circuitry to:
send, to a sink circuitry, an instruction to reduce a size of an active area of a display panel, wherein the active area is to become a smaller active area; and
render frames at a reduced resolution, wherein the reduced resolution corresponds to the smaller active area of the display panel; and
the sink circuitry to:
receive, from the source circuitry, the instruction to reduce the size of the active area of the display panel;
based on receiving the instruction, reduce the size of the active area of the display panel to form the smaller active area, wherein an area of the display panel outside the smaller active area becomes an inactive area of the display panel, and wherein the display panel consumes less power based on reducing the size of the active area; and
cause the frames to be displayed in the smaller active area of the display panel at the reduced resolution.

12. The system of claim 11, wherein the source circuitry is further to, before sending the instruction to reduce the size of the active area of the display panel:
determine that a battery level of the system is below a threshold.

13. The system of claim 11, wherein:
the source circuitry is further to send, to the sink circuitry, the frames to be displayed in the smaller active area of the display panel; and
the sink circuitry is further to:
receive, from the source circuitry, the frames; and
cause the frames to be displayed in the smaller active area of the display panel.

14. The system of claim 11, wherein:
the source circuitry comprises a display controller, wherein the display controller is to send, to a timing controller, the instruction to reduce the size of the active area of the display panel; and
the sink circuitry comprises the timing controller, wherein the timing controller is to cause the size of the active area of the display panel to be reduced.

15. The system of claim 14, wherein the sink circuitry further comprises a power management unit (PMU), wherein the PMU is to:
remove power to the area of the display panel outside the smaller active area; or
reduce power to the area of the display panel outside the smaller active area.

16. The system of claim 11, wherein the source circuitry further comprises a graphics processing unit (GPU), wherein the GPU is to render the frames at the reduced resolution.

17. The system of claim 11, wherein the sink circuitry to reduce the size of the active area of the display panel is further to:
deactivate one or more row drivers of the display panel, wherein the one or more row drivers control one or more rows of the display panel, wherein the one or more rows are within the inactive area; or
deactivate one or more column drivers of the display panel, wherein the one or more column drivers control one or more columns of the display panel, wherein the one or more columns are within the inactive area.

18. One or more non-transitory computer-readable storage media storing computer-executable instructions that, when executed, cause a computer to perform a method, the method comprising:
receiving an instruction to reduce a size of an active area of a display panel;
based on the instruction, reducing the size of the active area of the display panel, wherein the active area becomes a smaller active area, wherein an area of the display panel outside the smaller active area becomes an inactive area of the display panel, and wherein the display panel consumes less power based on reducing the size of the active area;
rendering frames at a reduced resolution, wherein the reduced resolution corresponds to the smaller active area of the display panel; and
causing the frames to be displayed in the smaller active area of the display panel at the reduced resolution.

19. The one or more non-transitory computer-readable storage media of claim 18, wherein reducing the size of the active area of the display panel comprises:
removing power to pixels in the inactive area;
reducing power to the pixels in the inactive area; or
setting a color of the pixels in the inactive area to black.

20. The one or more non-transitory computer-readable storage media of claim 18, wherein reducing the size of the active area of the display panel comprises:
turning off one or more backlights for one or more dimming zones of the display panel, wherein the one or more dimming zones are outside the smaller active area of the display panel.
